(19) United States
(12) Patent Application Publication
(10) Pub. No.: US 2025/0211967 A1
(43) Pub. Date: Jun. 26, 2025

(54) METHODS FOR EXPOSURE OF DATA/ANALYTICS OF A COMMUNICATION NETWORK IN ROAMING SCENARIO

(71) Applicant: Telefonaktiebolaget LM Ericsson (publ), Stockholm (SE)

(72) Inventors: Zhang FU, Stockholm (SE); Miguel Angel GARCIA MARTIN, Pozuelo de Alarcon (Madrid) (ES); Ralf KELLER, Würselen (DE); Antonio INIESTA GONZALEZ, Madrid (ES); Ann-Christine SANDER, Skepplanda (SE); Ulf MATTSSON, Kungsbacka (SE); Maria Belen PANCORBO MARCOS, Madrid (ES)

(73) Assignee: Telefonaktiebolaget LM Ericsson (publ), Stockholm (SE)

(21) Appl. No.: 18/848,925

(22) PCT Filed: Mar. 13, 2023
(86) PCT No.: PCT/EP2023/056311

§ 371 Date: Sep. 20, 2024

(30) Foreign Application Priority Data
Mar. 25, 2022 (EP) 22382275.0

(51) Int. Cl. H04W 8/08; H04W 84/04

(52) U.S. Cl. CPC H04W 8/08; H04W 84/042

(57) ABSTRACT

Embodiments include methods for a network data analytics function (NWDAF) of a communication network. Such methods include receiving, from a data consumer network function (NF) of the communication network, a request for an analytic or data associated with a user equipment (UE). Such methods include, in response to determining a need to collect the analytic or data from a first communication network, obtaining information identifying a gateway exposure function (cGEF) of the communication network, from a network repository function (NRF) of the communication network. Such methods include, based on the obtained information, sending to the cGEF a request for the analytic or data associated with the UE and receiving the requested analytic or data from the cGEF. Other embodiments include complementary methods for a cGEF, an NRF, a producer GEF (pGEF), and a network function (NF), as well as network nodes or functions that implement such functionality.

### TECHNICAL FIELD

The present disclosure relates generally to the field of communication networks, and more specifically to techniques for exposure of data and/or analytics of a first communication network to a second communication network, such as data and/or analytics pertaining to subscribers of the second communication network who are roaming into the first communication network.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G network architecture, consisting of a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via respective interfaces 102, 152. More specifically, gNBs 100, 150 can be connected to one or more Access and Mobility Management Functions (AMFs) in the 5GC via respective NG-C interfaces. Similarly, gNBs 100, 150 can be connected to one or more User Plane Functions (UPFs) in the 5GC via respective NG-U interfaces. Various other network functions (NFs) can be included in the 5GC, as described in more detail below.

In addition, the gNBs 100, 150 can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs 100, 150 can support frequency division duplexing (FDD), time division duplexing (TDD), or a combination thereof. Each of the gNBs 100, 150 can serve a geographic coverage area including one or more cells and, in some cases, can provide coverage in the respective cells via various directional beams.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB 100, 150 is connected to all 5GC nodes within an “AMF Region.”

The NG RAN nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs are logical nodes that host higher-layer protocols and perform various gNB functions such controlling the operation of DUs. DUs are logical nodes that host lower layer protocols and can include various subsets of the gNB functions. As such, CUs and DUs can include various circuitry needed to perform their respective functions, including processing circuitry, communication interface circuitry, power supply circuitry, etc.

A gNB-CU 110 connects to one or more gNB-DUs 120, 130 over respective F1 logical interfaces, such as interfaces 122 and 132 shown in FIG. 1. However, a gNB-DU 120, 130 can be connected to only one gNB-CU 110, with the gNB-CU 110 and connected gNB-DU(s) 120, 130 visible to other gNBs 100, 150 and the 5GC as a gNB 100, 150. In other words, the F1 interface is not visible beyond gNB-CU 110.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

A 5GC NF that is of particular interest in the present disclosure is the Network Data Analytics Function (NWDAF). This NF provides network analytics information (e.g., statistical information of past events and/or predictive information) to other NFs.

Indirect communication in SBA was specified in 3GPP Rel-16, using a Service Communication Proxy (SCP) as a standardized proxy between Service Consumers and Service Producers. 3GPP Rel-17 enhanced SBA with a Data Management Framework that includes a Data Collection Coordination Function (DCCF) and an optional messaging framework. Data consumers ask DCCF for data collection in relation to a data producer. The DCCF subscribes to the data source (if it does not have a subscription already) and then coordinates the request and data delivery, e.g., using the messaging framework. The data producer inputs the requested data to the messaging framework, which delivers the data to the data consumer.

### SUMMARY

In Rel-17, data and analytics are only available for non-roaming scenarios where a UE is operating in its home public land mobile network (HPLMN) and both the data consumer and data producer are in the HPLMN. It is also desirable to expose data and analytics in roaming scenarios where the UE is operating in a visited PLMN (VPLMN) and at least one of the data consumer and data producer are in the VPLMN. Current solutions do not address this need.

Accordingly, embodiments of the present disclosure address these and other problems, issues, and/or difficulties, thereby enabling the otherwise-advantageous implementation of data and analytics functionality in a 5G system.

Some embodiments of the present disclosure include methods (e.g., procedures) for an NWDAF of a communication network (e.g., 5GC).

These exemplary methods can include receiving, from a data consumer NF of the communication network, a request for an analytic or data associated with a UE. These exemplary methods can also include, in response to determining a need to collect the analytic or data from a first communication network, obtain information identifying a gateway exposure function (cGEF) of the communication network, from an NRF of the communication network. These exemplary methods can also include, based on the obtained information, sending to the cGEF a request for the analytic or data associated with the UE. These exemplary methods can also include receiving the requested analytic or data from the cGEF.

In some embodiments, the communication network is the UE's VPLMN and the first communication network is the UE's HPLMN. In some of these embodiments, the request includes an identifier of the UE and obtaining information identifying the cGEF from the NRF includes the following operations:
obtaining an identifier of the UE's HPLMN from the UE identifier included in the request;
sending the identifier of the UE's HPLMN to the NRF; and.
receiving the information identifying the cGEF from the NRF.

In some of these embodiments, determining the need to collect the analytic or data from the first communication network is based on one of the following included with the request: an analytic identifier, a Subscription Permanent Identifier (SUPI) or an explicit indication that the requested analytic requires data from the first communication network.

In other embodiments, the communication network is the UE's HPLMN and the first communication network is the UE's VPLMN. In some of these embodiments, these exemplary methods can also include obtaining, from a UDM of the communication network, an indication of consent by a user of the UE for collection of the analytic or data.

In some of these embodiments, determining the need to collect the analytic or data from the first communication network includes obtaining, from the UDM, an indication that the UE is roaming outside of the HPLMN. In some further variants, the indication that the UE is roaming outside of the HPLMN is an identifier associated with an AMF serving the UE, which includes an identifier of the VPLMN.

Other embodiments include exemplary methods (e.g., procedures) for a consumer GEF (cGEF) of a communication network (e.g., 5GC).

These exemplary methods can include receiving, from an NWDAF of the communication network, a request for an analytic or data that is generated by a data producer NF of a first communication network. These exemplary methods can also include forwarding the request for the analytic or data to a gateway exposure function (pGEF) of the first communication network. These exemplary methods can also include receiving the requested analytic or data from the pGEF and forward the received analytic or data to the NWDAF.

In some embodiments, these exemplary methods can also include discovering the pGEF of the first communication network via an NRF of the communication network. In some embodiments, these exemplary methods can also include, before receiving the request, registering with the NRF identities of one or more other communication networks from which the cGEF can collect analytics or data, including the first communication network.

In some embodiments, the cGEF is provisioned with policies and/or constraints for one or more of the following: collecting analytics or data from other communication networks, and providing analytics or data to other communication networks. In such embodiments, forwarding the request for the analytic or data to the pGEF is performed in accordance with the provisioned policies and/or constraints.

In some embodiments, the analytic or data is associated with a UE that is roaming in a VPLMN. In some of these embodiments, the communication network is the UE's VPLMN and the first communication network is the UE's HPLMN. In other embodiments, the communication network is the UE's HPLMN and the first communication network is the UE's VPLMN. In various embodiments, the cGEF is part of one of the following in the communication network: the NWDAF, a DCCF, a network exposure function (NEF), a service communication proxy (SCP), or a security edge protection proxy (SEPP).

Other embodiments include exemplary methods (e.g., procedures) for a producer GEF (pGEF) of a communication network (e.g., 5GC).

These exemplary methods can include receiving, from a cGEF of a first communication network, a request for an analytic or data that is generated by a data producer NF of the communication network. These exemplary methods can also include collecting the analytic or data from the data producer NF in accordance with the request. These exemplary methods can also include sending to the cGEF the collected analytic or data, or a representation thereof.

In some embodiments, these exemplary methods can also include, before receiving the request, registering with an NRF of the communication network identities of one or more other communication networks from which the pGEF can collect analytics or data.

In some embodiments, the pGEF is provisioned with policies and/or constraints for one or more of the following: collecting analytics or data from other communication networks, and providing analytics or data to other communication networks. In some of these embodiments, these exemplary methods can also include processing the collected data or analytic in accordance with the provisioned polices and/or constraints to generate the representation sent to the cGEF. In some variants, processing the collected data can include one or more of the following operations: removing sensitive or confidential data, modifying granularity of the analytic or data, formatting of the analytic or data, anonymization of the analytic or data.

In some embodiments, the analytic or data is associated with a UE that is roaming in a VPLMN. In some of these embodiments, the communication network is the UE's VPLMN and the first communication network is the UE's HPLMN. In other embodiments, the communication network is the UE's HPLMN and the first communication network is the UE's VPLMN. In some of these embodiments, these exemplary methods can also include obtaining, from a UDM of the communication network, an indication of consent by a user of the UE for collection of the analytic or data. Collecting the analytic or data is based on the indication of consent.

In various embodiments, the pGEF is part of one of the following in the communication network: an NWDAF, a DCCF, an NEF, an SCP, or a SEPP.

Other embodiments include methods (e.g., procedures) for a network repository function (NRF) of a communication network.

These exemplary methods can include registering, for a GEF of the communication network, identities of one or more other communication networks from which the GEF can collect analytics or data. These exemplary methods can also include subsequently facilitating one or more of the following in relation to collecting analytics or data by a data consumer NF from a data producer NF:
discovery of the GEF, as a pGEF, by a cGEF associated with the data consumer NF; and
discovery by the GEF, as a cGEF, of a pGEF associated with the data producer NF.

In some embodiments, the analytics or data are associated with a UE that is roaming in a VPLMN. In some of these embodiments, the communication network is the UE's VPLMN and the data consumer NF is in the UE's HPLMN. In other embodiments, the communication network is the UE's HPLMN and the data consumer NF is in the UE's VPLMN.

Some embodiments of the present disclosure include methods (e.g., procedures) for a network function (NF) of a communication network (e.g., 5GC).

These exemplary methods can include, in response to determining a need to obtain an analytic or data, that is associated with a user equipment (UE), from a first communication network, obtaining information identifying a gateway exposure function (cGEF) of the communication network, from an NRF of the communication network, wherein the cGEF is part of a network data analytics function (NWDAF) of the communication network. These exemplary methods can also include, based on the obtained information, sending to the cGEF a request for the analytic or data associated with the UE. These exemplary methods can also include receiving the requested analytic or data from the cGEF.

In some embodiments, the communication network is the UE's VPLMN and the first communication network is the UE's HPLMN.

In some of these embodiments, determining the need to collect the analytic or data from the first communication network is based on one of the following included with the request: an analytic identifier, a Subscription Permanent Identifier (SUPI) of the UE, or an explicit indication that the requested analytic requires data from the first communication network.

In other embodiments, the communication network is the UE's HPLMN and the first communication network is the UE's VPLMN. In some of these embodiments, these exemplary methods can also include obtaining, from a UDM of the communication network, an indication of consent by a user of the UE for collection of the analytic or data.

In some of these embodiments, determining the need to collect the analytic or data from the first communication network includes obtaining, from the UDM, an indication that the UE is roaming outside of the HPLMN. In some further variants, the indication that the UE is roaming outside of the HPLMN is an identifier associated with an AMF serving the UE, which includes an identifier of the VPLMN.

Other embodiments include exemplary methods (e.g., procedures) for a consumer GEF (cGEF) of a communication network (e.g., 5GC), wherein the cGEF is part of a network data analytics function (NWDAF) of the communication network.

These exemplary methods can include receiving, from an NF of the communication network, a request for an analytic or data that is generated by a data producer network function of a first communication network. These exemplary methods can also include forwarding the request for the analytic or data to a gateway exposure function (pGEF) of the first communication network. These exemplary methods can also include receiving the requested analytic or data from the pGEF and forward the received analytic or data to the NF.

In some embodiments, these exemplary methods can also include discovering the pGEF of the first communication network via an NRF of the communication network.

In some embodiments, the cGEF is provisioned with policies and/or constraints for one or more of the following: collecting analytics or data from other communication networks, and providing analytics or data to other communication networks. In such embodiments, forwarding the request for the analytic or data to the pGEF is performed in accordance with the provisioned policies and/or constraints.

In some embodiments, the analytic or data is associated with a UE that is roaming in a VPLMN. In some of these embodiments, the communication network is the UE's VPLMN and the first communication network is the UE's HPLMN. In other embodiments, the communication network is the UE's HPLMN and the first communication network is the UE's VPLMN. Other embodiments include NWDAFs, GEFs, NRFs and NFs (or network nodes hosting the same) that are configured to perform the operations corresponding to any of the exemplary methods described herein. Other embodiments also include non-transitory, computer-readable media storing computer-executable instructions that, when executed by processing circuitry associated with such NWDAFs, GEFs, NRFs and NFs, configure the same to perform operations corresponding to any of the exemplary methods described herein.

These and other embodiments or aspects described herein can improve inter-network data collection in UE roaming scenarios based on a GEF that handles requests from data consumer NFs towards data producer NFs in other networks. Accordingly, data producer NFs do not need to implement regulatory constraints and agreements for roaming cases, and impact to existing 3GPP specifications (and existing implementations) is relatively small. In this manner, embodiments can facilitate inter-network data collection and analysis, which can improve network performance.

These and other objects, features, and advantages of the present disclosure will become apparent upon reading the following Detailed Description in view of the Drawings briefly described below.

### BRIEF DESCRIPTION OF THE DRAWINGS

Some of the embodiments contemplated herein will now be described more fully with reference to the accompanying drawings, in which:

FIGS. 1-2 illustrate various aspects of an exemplary 5G network architecture.

FIG. 3(a) illustrates a high-level view of the 3GPP Rel-17 Data Management Framework, and FIG. 3(b) illustrates data delivery via a Messaging Framework.

FIGS. 4-5 are signal flow diagrams illustrating two exemplary scenarios for collection of analytics or data associated with a UE roaming in a VPLMN, according to various embodiments of the present disclosure.

FIG. 6 shows an exemplary method (e.g., procedure) for an NWDAF of a communication network, according to various embodiments of the present disclosure.

FIG. 7 shows an exemplary method (e.g., procedure) for a consumer gateway exposure function (cGEF) of a communication network, according to various embodiments of the present disclosure.

FIG. 8 shows an exemplary method (e.g., procedure) for a producer gateway exposure function (pGEF) of a communication network, according to various embodiments of the present disclosure.

FIG. 9 shows an exemplary method (e.g., procedure) for an NRF of a communication network, according to various embodiments of the present disclosure.

FIG. 10 shows an exemplary method (e.g., procedure) for an NF of a communication network, according to various embodiments of the present disclosure.

FIG. 11 shows an exemplary method (e.g., procedure) for a consumer gateway exposure function (cGEF) of a communication network, according to various embodiments of the present disclosure.

FIG. 12 shows a communication system according to various embodiments of the present disclosure.

FIG. 13 shows a UE according to various embodiments of the present disclosure.

FIG. 14 shows a network node according to various embodiments of the present disclosure.

FIG. 15 shows host computing system according to various embodiments of the present disclosure.

FIG. 16 is a block diagram of a virtualization environment in which functions implemented by some embodiments of the present disclosure may be virtualized.

FIG. 17 illustrates communication between a host computing system, a network node, and a UE via multiple connections, according to various embodiments of the present disclosure.

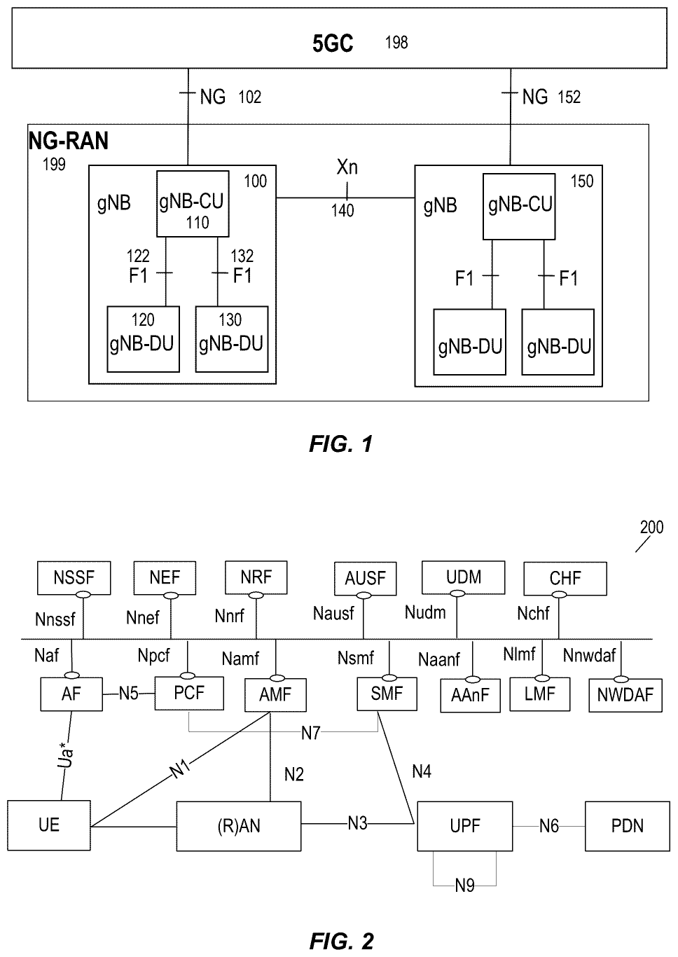

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, mobile terminals (MTs), etc.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device.
Service: As used herein, the term “service” refers generally to a set of data, associated with one or more applications, that is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a wireless device or a network node may be distributed over a plurality of wireless devices and/or network nodes. Furthermore, although the term “cell” is used herein, it should be understood that (particularly with respect to 5G NR) beams may be used instead of cells and, as such, concepts described herein apply equally to both cells and beams.

FIG. 2 shows an exemplary architecture of a 5G network (200) with service-based interfaces. The architecture shown in FIG. 2 includes the following NFs:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF) with Nnwdaf interface—provides network analytics information (e.g., statistical information of past events and/or predictive information) to other NFs on a network slice instance level.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

The NRF allows every NF to discover the services offered by other NFs, and Data Storage Functions (DSF) allow every NF to store its context. In addition, the NEF provides exposure of capabilities and events of the 5GC to AFs within and outside of the 5GC. For example, NEF provides a service that allows an AF to provision specific subscription data (e.g., expected UE behavior) for various UEs.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

3GPP Rel-17 enhances the SBA by adding a Data Management Framework that includes a Data Collection Coordination Function (DCCF) and a messaging framework, which is defined in detail in 3GPP TR 23.700-91 (v17.0.0) section 6.9 and in 3GPP TS 23.288 v17.4.0, section 5A.3.2. The Data Management Framework is backward compatible with a Rel-16 NWDAF function, described above.

For Rel-17, the baseline for services offered by the DCCF (e.g., to an NWDAF Analytics Function) are the Rel-16 NF Services used to obtain data. For example, the baseline for the DCCF service used by an NWDAF consumer to obtain UE mobility data is Namf_EventExposure. The 5G system architecture also allows any NF to obtain analytics from an NWDAF using a DCCF function and associated Ndccf services. The NWDAF can also perform storage and retrieval of analytics information from an Analytics Data Repository Function (ADRF).

A Rel-16 NWDAF can coexist with a Rel-17 NWDAF and the Data Management Framework. A Rel-16 NWDAF continues to request data directly from NFs without using the Data Management Framework and provides analytics to consumers that discover the Rel-16 NWDAF. A Rel-17 NWDAF can request data from the Data Management Framework, and if the data is not collected already, the Data Management Framework would request the data from a data source. In other words, a data source would independently send Data to the Rel-16 NWDAF that sent a request directly to the data Source, and to the Data Management Framework that sent a request for the Rel-17 NWDAF.

In Rel-17, the NWDAF is decomposed by moving Data Collection (including the task of identifying the Data Source) to the Data Management Framework. The Rel-17 NWDAF requests data from the Data Management Framework but may not query other NFs (e.g., NRF, UDM, etc.) to determine which NF instance serves a UE, nor need it be concerned about life cycles of Data Source NFs, as was the case for Rel-16 NWDAF. This decomposition also allows other NFs to obtain data via the Data Management Framework and avoids duplicate data collection from the same data source. The Rel-17 NWDAF (without Data Collection) may be referred to as the “NWDAF Analytics Function.”

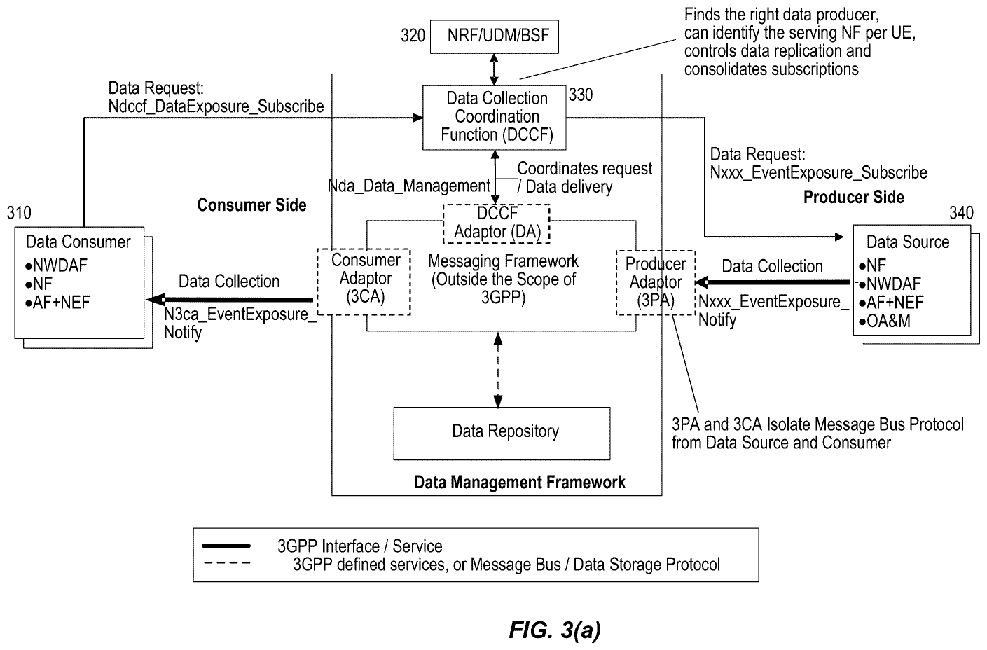

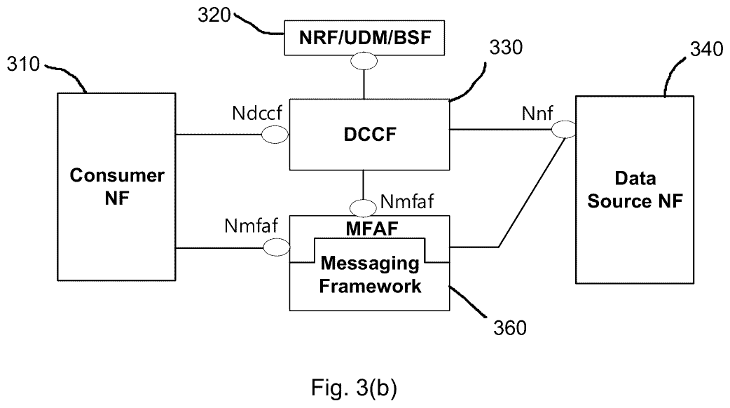

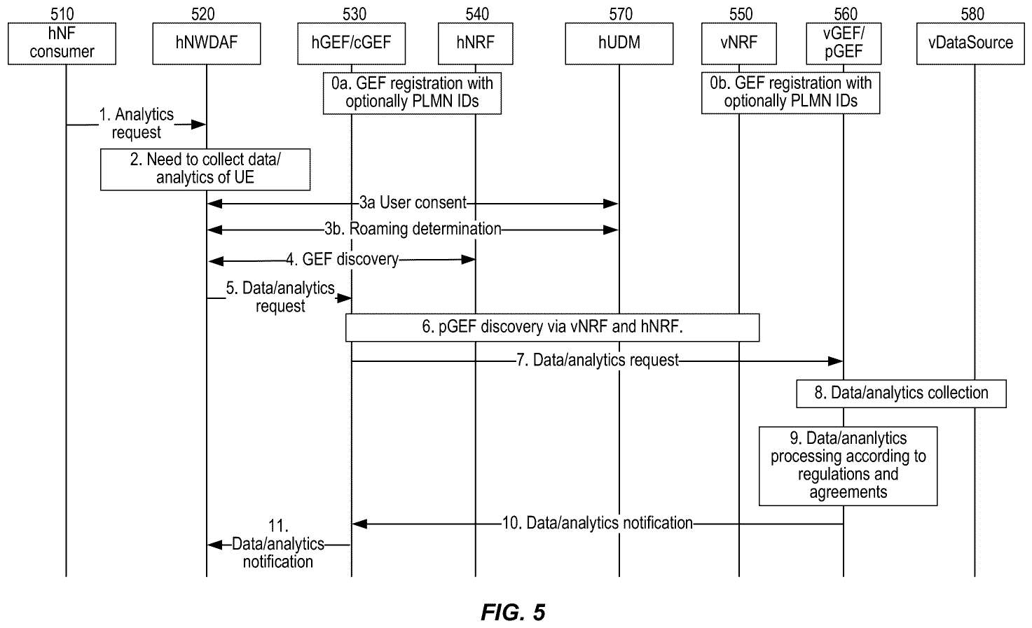

FIG. 3(a) illustrates a high-level view of the Rel-17 Data Management Framework based on 3GPP TR 23.700-91 (v17.0.0) section 6.9. FIG. 3(b) illustrates data delivery via a Messaging Framework as shown in 3GPP TS 23.288 v17.4.0, section 5A.3.2, Figure 5A.3.2-1. The main components are the DCCF 330 that communicates with other NFs, the Messaging Framework 360, and a Data Repository. The Messaging Framework 360 optionally includes a DCCF Adaptor (DA) used to communicate with the DCCF, a 3GPP Consumer Adaptor (3CA) and/or a 3GPP Producer Adaptor (3PA) used to communicate with a Data Consumer 310 and a Data Source 340, respectively. The DA, 3CA, and 3PA may be standalone or combined with the Messaging Framework 360, Data Consumer 310, and Data Source 340, respectively. Exemplary Data Consumers include the NWDAF Analytics Function an NF requesting analytics, but as with other NF services, nothing precludes other Consumer NFs. The Data Management Framework is compatible with both a 3GPP-defined Data Repository Function for ML/Analytics and Data Repositories that are not 3GPP-defined.

DCCF 330 is a control-plane function that coordinates data collection and triggers data delivery to Data Consumers. A DCCF 330 may support multiple Data Sources 340, Data Consumers 310, and Message Frameworks 360. However, to prevent duplicate data collection, each Data Source 340 is associated with only one DCCF 330. DCCF 330 provides the 3GPP defined Ndccf_DataManagement Service to Data Consumers 310 and uses the services of Data Sources 340 to obtain data. Although FIG. 3 shows one DCCF 330 for the 5GC, there can be multiple DCCF instances associated with different network slices, different geographic regions where Data Sources 340 reside, or different types of Data Sources 340. A DCCF 330 registers with NRF 320 and is discovered by Consumers 310 (or SCP) using the registration and discovery procedures defined for the NF Service Framework in 3GPP TS 23.502 (v16.7.0).

DCCF 330 receives data requests from Data Consumers via the Ndccf_DataManagement service. If a Data Source 340 is not specified in the Data Request, DCCF 330 determines the Data Source 340 that can provide the data requested by the Data Consumer 310. For example, if the request is for UE-specific data, DCCF 330 may query the other NFs (320, e.g., NRF, UDM, etc.) to determine which NF instance is serving the UE. If the Data Source 340 is specified in the Data Request (e.g., the Data Consumer 310 is configured with Data Sources 340), DCCF 330 checks whether the data is already collected from the Data Source 340. If not, DCCF 330 will request the data from the specified Data Source 340. If the requested data is partially covered by existing subscriptions with the Data Source 340, the DCCF 330 sends a request to the Data Source 340 to modify one or more subscriptions to accommodate both the previous requests for data and the new request for data.

Additionally, DCCF 330 may determine if the requested data is currently being produced by any Data Source 340 and being provided to the Messaging Framework 360. If the requested data is not being produced and/or provided, DCCF 330 sends a new subscription/request towards the Data Source 340 to trigger a new data collection, and DCCF 330 then subscribes with the messaging framework for the Data Consumer 310 to receive future notifications associated with the desired Data Source 340.

The Messaging Framework 360 formats and processes data received from the Data Source NF 340 and sends notifications to all Data Consumers 310 and Notification Endpoints specified by Data Consumers 310 or determined by the DCCF 330. Each Data Consumer 310 may specify in its request to the DCCF 330 multiple notification endpoints, which may include the requesting Data Consumer 310, an ADRF or other NFs. The DCCF 330 may also select an ADRF or other notification endpoint based on configuration. While the Messaging Framework 360 is not standardized by 3GPP, a Messaging Framework Adaptor NF (MFAF) offers 3GPP-defined services that allow the 5GS to interact with the Messaging Framework 360. Internally, the Messaging Framework 360 may for example support a pub-sub pattern, where received data are published to the Messaging Framework 360 and requests from 3GPP Consumers result in Messaging Framework specific subscriptions. Alternatively, the Messaging Framework 360 may support other protocols outside of the scope of 3GPP.

DCCF 330 uses the Nmfaf_3daDataManagement service to convey information so that the Messaging Framework 360 can recognize data that are received from a Data Source 340. The MFAF can obtain data received by the Messaging Framework 360, process and format the data according to processing and formatting instructions for each consumer/notification endpoint, and send notifications or responses to the Data Consumers 310.

When data is received (e.g., due to event notification), the Messaging Framework 360 processes it according to the formatting and processing instructions for each consumer/notification endpoint before sending the respective notifications. Note that notifications sent via the Nmfaf_3caDataManagement service have the same content as those sent via a Ndccf_DataManagement service for data delivery via the DCCF 330.

The Nnwdaf_DataManagement service enables consumers to subscribe/unsubscribe for data/analytics produced by NWDAF, be notified about data exposed by NWDAF, or fetch the subscribed data. It enables consumers to request generation of bulk data for Event IDs and/or Analytics IDs and to retrieve the requested data.

More specifically, the Nnwdaf_DataManagement_Subscribe service operation of the Nnwdaf_DataManagement service enables consumers to subscribe to receive data or historical analytics (which is regarded as a kind of data). If the data is already defined in NWDAF, then the subscription is updated. The required service operation inputs include Data Specification or Analytics Specification, Notification Target Address, and Notification Correlation ID.

When the required data is a bulk data for Event IDs received from NFs, the Data Specification includes a set of Event IDs, Event Filter Information, Target of Event Reporting, and bulk data type. When the required data is a bulk data for Analytics ID, the Data Specification includes Target of Reporting with the set of Analytics ID(s) to generate bulk data, bulk data type, analytics stage, Filter Information with Target of Analytics Information, and Analytics Filter Information. These parameters are further defined in 3GPP 23.288 (v17.3.0) section 6.2.6.1.

When the required data is historical analytics, the Analytics Specification is included in the required input parameters and identifies the historical analytics to be collected, based on Analytics ID(s), Target of Analytics Reporting, Analytics Filter information and other input parameters for NWDAF services. These parameters are further defined in 3GPP 23.288 (v17.3.0) sections 7.2 and 7.3.

In any case, event filter information, target of event reporting, and bulk data type can be provided per individual Event ID in a set of Event IDs to generate bulk data. Likewise, bulk data type, analytics stage, target of analytics information, analytics filter information can be provided per individual Analytics ID in a set of Analytics IDs to generate bulk data.

Optional inputs to the Nnwdaf_DataManagement_Subscribe service operation include service operation, bulk data formatting and processing, data source, ADRF information to store data used for generated bulk data, and ADRF ID or NWDAF ID (or ADRF Set ID or NWDAF Set ID) storing historical data to be used for bulk data generation. The bulk data formatting and processing parameters include parameters defined in 3GPP 23.288 (v17.3.0) section 5A.4 as well as periodic bulk data notification, feature type, time window, minimum and/or maximum number of samples, fetch flag, bulk data deadline, notification event clubbing, and processing rules. The following inputs can be provided per individual Event ID or Analytics ID included in the data specification: service operation (in the case of Event IDs), bulk data formatting and processing, data source, and ADRF information to store data used for generated bulked data, ADRF ID or NWDAF ID (or ADRF Set ID or NWDAF Set ID) storing historical data to be used for bulked data generation.

When the subscription is accepted, the output of Nnwdaf_DataManagement_Subscribe service operation is a subscription correlation ID (required for management of the requested subscription). When the subscription is not accepted, the output of Nnwdaf_DataManagement_Subscribe service operation is an error response. For example, when the target of event reporting or target of reporting input parameter is a subscription permanent identifier (SUPI) or a generic public subscription identifier (GPSI), an error is sent to the consumer when the subscription request is not accepted, e.g., due to no user consent. As another example, when the target of event reporting or target of reporting input parameter is an internal group ID, a list of SUPIs/GPSI(s), or any UE, no error is sent but a SUPI or GPSI is skipped when user consent is not granted.

In Rel-17, data and analytics are only available for non-roaming scenarios where a UE is operating in its home public land mobile network (HPLMN) and both the data consumer and data producer are in the HPLMN. It is also desirable to expose data and analytics in roaming scenarios where the UE is operating in a visited PLMN (VPLMN) and at least one of the data consumer and data producer are in the VPLMN.

3GPP TR 23.700-81 (v0.1.0) for Rel-18 discusses in section 5.3.1 how, in a roaming scenario, the HPLMN may need to collect data or consume analytics from the VPLMN or vice versa. The data or analytics may relate to particular UEs, or it may contain information about all UEs or groups of UEs. Both VPLMN and HPLMN need the ability to control the amount of data exposed and to abstract or hide network-internal aspects based on user consent, operator policy, regulatory constraints, and/or roaming agreements.

Use cases for data exchange and analytics exposure between HPLMN and VPLMN require further investigation. Furthermore, for each use case, there is a need to identify which raw data and/or existing or new analytics IDs needs to be exchanged, which existing analytics ID can be enhanced, and which new analytics ID need to be generated for a roaming user based on the exchanged data.

Additionally, there is a need to determine if any architecture enhancements are needed to support this exchange in roaming scenarios, as well as if any corresponding enhancements to NFs in HPLMN and VPLMN are needed. For example, there may be need for enhancements to data collection using DCCF 330, to data storage using ADRF, or to security and privacy of the data and analytics exchange between PLMNs.

Accordingly, Applicants have recognized the following problems, issues, and/or difficulties that need to be addressed:
Support must be provided for a VPLMN to collect analytics and/or source data from VPLMN NFs. Existing data collection must honor user data consent for user related data collection. The HPLMN may impose constraints on the type or amount of data collected. The constraints may differ for different VPLMNs.
Support must be provided for the HPLMN to collect analytics and/or source data from VPLMN NFs. The vPLMN may impose constraints on the type or amount of data collected. The constraints may differ for different hPLMNs.
Any mechanism must scale to support the typical number of roaming agreements that a given network has established.
NF consumer of analytics in PLMN A may need to get analytics for an inbound roamer from PLMN B (i.e., HPLMN), but the current framework for analytics does not allow a NF consumer to indicate this need.

Embodiments of the present disclosure address these and other problems, issues, and/or difficulties by providing novel, flexible, and efficient techniques for data collection in roaming scenarios. Since data/analytics exposure between two PLMNs may be done according to the regulatory constraints and agreement between the two PLMNs, it is not scalable to enforce every data source to implement regulatory constraints and roaming agreements. This can be done instead by a Gateway Exposure Function (GEF) for a PLMN. The GEF being responsible for data/analytics exposure to other PLMNs and is provisioned with constraints on type and amount of data exposed to each PLMN with a roaming agreement. The GEF is also responsible for enforcing obtaining any needed user consent for data collection.

For example, when a data/analytics consumer in PLMN A needs to collect data/analytics from PLMN B, the consumer contacts the consumer GEF (cGEF, e.g., hGEF or vGEF) in PLMN A, which contacts the producer GEF (pGEF, e.g., vGEF or hGEF) in PLMN B, which discovers the data/analytics producer in PLMN B and collects the data/analytics. The GEF is also responsible for data/analytics manipulation before sending to the other PLMN according to the regulatory constraints and agreement.

In some embodiments described herein, a NF that needs analytics or data from another PLMN contacts the GEF. In some embodiments described herein, a NF that needs analytics or data from another PLMN contacts the NWDAF.

One exemplary benefit is that data sources (e.g., producer NFs) do not need to implement regulatory constraints and agreements for roaming cases. Another exemplary benefit is that impact to existing 3GPP specifications (and existing implementations) is relatively small.

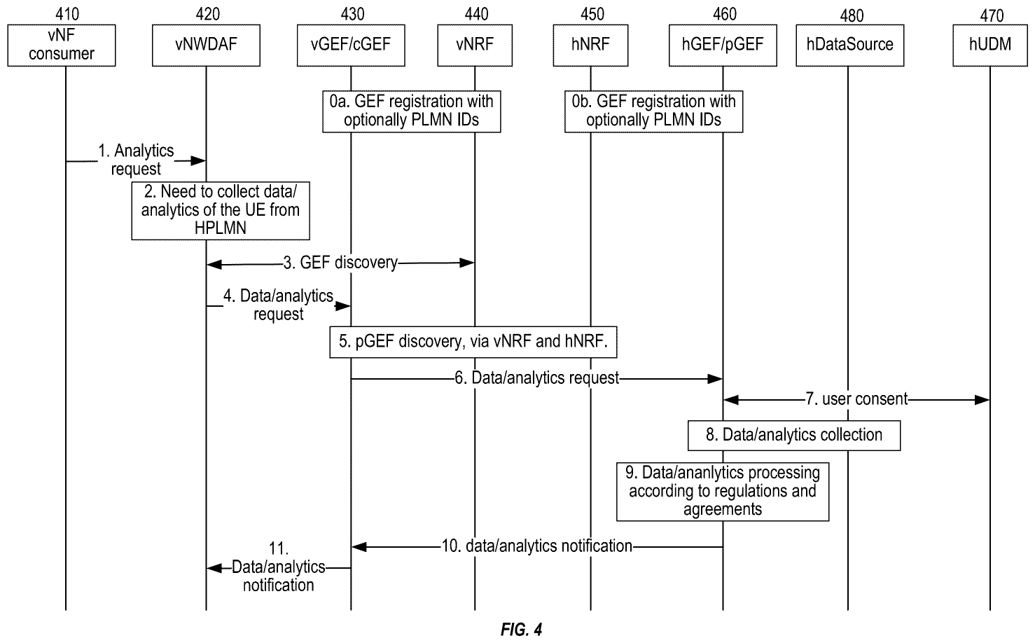

FIG. 4 is a flow diagram of an exemplary procedure when a data/analytics consumer NF is in a VPLMN and the NWDAF in the VPLMN (vNWDAF) needs to collect data/analytics from the UE's HPLMN, according to some embodiments of the present disclosure. In particular, the procedure in FIG. 4 involves the data consumer (410, referred to as vNF consumer), the vNWDAF (420), a VPLMN cGEF (430, also referred to as vGEF), a VPLMN NRF (440, referred to as vNRF), an HPLM NRF (450, referred to as hNRF), an HPLMN pGEF (460, also referred to as hGEF), an HPLMN UDM (470, referred to as hUDM), and an HPLMN data producer NF (480, referred to as hDataSource). For brevity, these elements and/or functions will be referred to in the following description without their respective reference numbers. Although operations shown in FIG. 4 are given numerical labels, this is intended to facilitate explanation rather to imply any strict ordering of the operations, unless specifically stated otherwise.

Before operation 0, it is assumed that both vGEF 430 and hGEF 460 have been provisioned, by their respective operators, with policies and constraints related to exporting data to or from roaming/home networks. In operation 0, the GEFs register in their respective NRFs, including IDs of the PLMNs from which they can collect data/analytics.

In operation 1, the vNF analytics consumer 410 (e.g., an AMF) subscribes to the vNWDAF 420 for an analytic for an inbound roaming UE. That is, a NF consumer indicates its need for an analytic for an inbound roaming UE. In operation 2, the vNWDAF 420 determines that it needs to collect data/analytics from the UE's HPLMN. For example, the data to be collected might be related to expected UE behavior. The vNF consumer 410 and the vNWDAF 420 obtain the HPLMN ID from the UE's SUPI. In the analytics request of operation 1, the analytics consumer may indicate to the vNWDAF 420 that the subscribed analytic needs data from the HPLMN, or the vNWDAF 420 can determine that based on an analytics ID associated with the subscribed analytic.

In operation 3, the vNWDAF 420 discovers vGEF 430 via vNRF 440 based on providing the HPLMN ID. The vNRF 440 provides the ID for the vGEF 430 that is responsible for collecting data/analytic from the VPLMN. operation 4, the vNWDAF 420 sends a data/analytics subscription request to the vGEF ID obtained in operation 3. In operation 5, the cGEF 430 (vGEF in this case) discovers the pGEF 460 (hGEF in this case) via vNRF 440 and hNRF 450. In operation 6, the vGEF 430 sends a data/analytics subscription request to the hGEF ID obtained in operation 5. The hGEF 460 checks roaming agreements, HPLMN policies, and regulatory constraints between HPLMN and originating VPLMN to determine if the request can be accepted or must be rejected.

Assuming the request is accepted, in operations 7-8 the hGEF 460 enforces user consent (i.e., for UE-related data collection) and collects data and/or analytics from the relevant hDataSource (e.g., one or more NFs) in the UE's HPLMN. That is, the GEF is responsible for enforcing obtaining any needed user consent for data collection. In operation 9, the hGEF 460 manipulates the collected data/analytics according to HPLMN policies, regulatory constraints, and roaming agreements. For example, the hGEF 460 can remove sensitive or confidential data, modify granularity of the data, perform anonymization, format the data, etc. That is, the GEF is responsible for data/analytics manipulation (before sending the data/analytics to the other PLMN) according to the regulatory constraints and agreement.

In operations 10-11, the hGEF 460 sends the data/analytics to vGEF 430, which forwards (i.e. sends) it to the vNWDAF 420. The vGEF 430 may also manipulate the data/analytics to a format that is requested by vNWDAF 420 and/or that vGEF 430 otherwise knows to be understandable by NWDAF.

FIG. 5 is a flow diagram of an exemplary procedure when a data/analytics consumer NF is in the UE's HPLMN and the NWDAF in the HPLMN (hNWDAF) needs to collect data/analytics from the UE's VPLMN (i.e., when the UE is roaming), according to other embodiments of the present disclosure. In particular, the procedure in FIG. 5 involves the analytics consumer (510, referred to as hNF consumer), the hNWDAF (520), an HPLMN cGEF (430, also referred to as hGEF), an HPLMN NRF (540, referred to as hNRF), a VPLM NRF (550, referred to as vNRF), a VPLMN pGEF (560, also referred to as vGEF), an HPLMN UDM (570, referred to as hUDM), and a VPLMN data producer NF (580, referred to as vDataSource). For brevity, these elements and/or functions will be referred to in the following description without their respective reference numbers. Although operations shown in FIG. 5 are given numerical labels, this is intended to facilitate explanation rather to imply any strict ordering of the operations, unless specifically stated otherwise.

The primary difference between FIGS. 4-5 is in operations 3-7. In operation 3a, the hNWDAF 520 enforces the user consent with the hUDM 570. In operation 3b, the hNWDAF 520 queries hUDM 570 to retrieve the GUAMI for the AMF that is serving the user in the VPLMN. The GUAMI contains a PLMN ID of the AMF, which can be used to determine whether or not the UE is roaming. In the scenario shown in FIG. 5, the retrieved GUAMI indicates that the user is roaming.

Operations 5-7 in FIG. 5 are similar to respective operations 4-6 in FIG. 4, except that in this case cGEF 530 is hGEF and pGEF 560 is vGEF. Note that operation 3b in FIG. 5 corresponds to operation 7 in FIG. 4. Operations 8-11 in FIG. 5 are similar to respective operations 8-11 in FIG. 4.

Although FIGS. 4-5 shows vGEF/hGEF as separate entities, each of them can be implemented in other NFs such as NWDAF, DCCF, NEF, SCP, SEPP, etc.

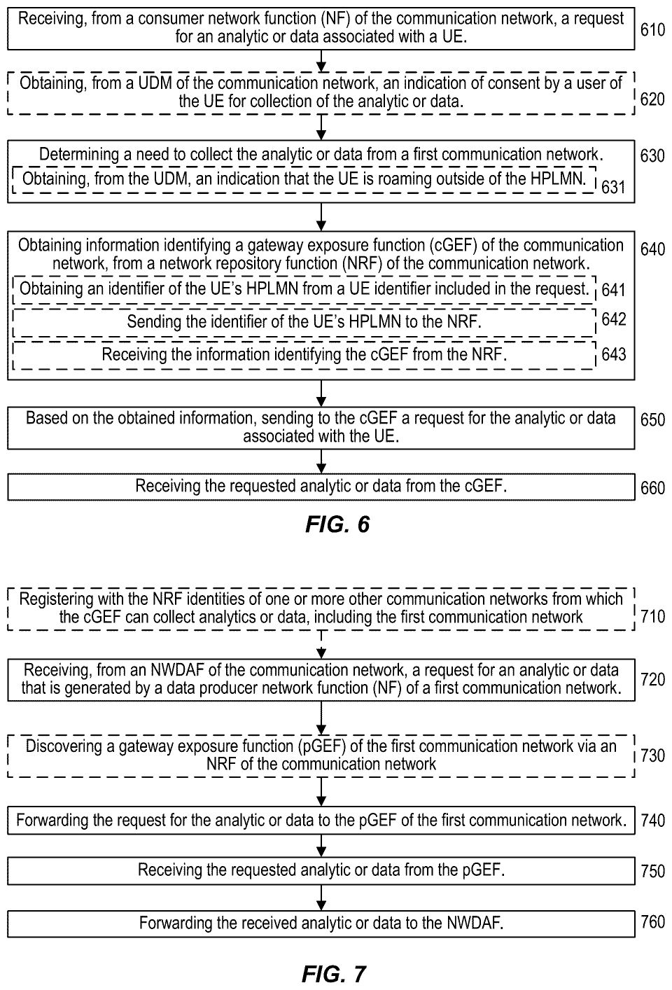

The embodiments described above can be further illustrated with reference to FIGS. 6-11, which depict exemplary methods (e.g., procedures) for an NWDAF, a consumer GEF, a producer GEF, an NRF, and a NF, respectively. Put differently, various features of the operations described below correspond to various embodiments described above. The exemplary methods shown in FIGS. 6-11 can be used cooperatively (e.g., with each other and with other procedures described herein) to provide benefits, advantages, and/or solutions to problems described herein. Although the exemplary methods are illustrated in FIGS. 6-11 by specific blocks in particular orders, the operations corresponding to the blocks can be performed in different orders than shown and can be combined and/or divided into blocks and/or operations having different functionality than shown. Optional blocks or operations are indicated by dashed lines.

More specifically, FIG. 6 illustrates an exemplary method (e.g., procedure) for an NWDAF of a communication network (e.g., 5GC), according to various embodiments of the present disclosure. The exemplary method shown in FIG. 6 can be performed by an NWDAF (or network node hosting the same) such as described elsewhere herein.

The exemplary method can include the operations of block 610, where the NWDAF can receive, from a data consumer NF of the communication network, a request for an analytic or data associated with a UE. The exemplary method can also include the operations of block 640, where the NWDAF can, in response to determining a need to collect the analytic or data from a first communication network (e.g., in block 630), obtain information identifying a gateway exposure function (cGEF) of the communication network, from an NRF of the communication network. The exemplary method can also include the operations of block 650, where the NWDAF can, based on the obtained information, send to the cGEF a request for the analytic or data associated with the UE. The exemplary method can also include the operations of block 660, where the NWDAF can receive the requested analytic or data from the cGEF.

In some embodiments, the communication network is the UE's visited public land mobile network (VPLMN) and the first communication network is the UE's home public land mobile network (HPLMN). FIG. 4 shows an example of these embodiments. In some of these embodiments, the request includes an identifier of the UE and obtaining information identifying the cGEF from the NRF in block 640 includes the following operations (with corresponding sub-block numbers):
(641) obtaining an identifier of the UE's HPLMN from the UE identifier included in the request;
(642) sending the identifier of the UE's HPLMN to the NRF; and
(643) receiving the information identifying the cGEF from the NRF.

In some of these embodiments, determining the need to collect the analytic or data from the first communication network (e.g., in block 630) is based on one of the following included with the request: an analytic identifier, a Subscription Permanent Identifier (SUPI) or an explicit indication that the requested analytic requires data from the first communication network.

In other embodiments, the communication network is the UE's HPLMN and the first communication network is the UE's VPLMN. FIG. 5 shows an example of these embodiments. In some of these embodiments, the exemplary method can also include the operations of block 620, where the NWDAF can obtain, from a UDM of the communication network, an indication of consent by a user of the UE for collection of the analytic or data.

In some of these embodiments, determining the need to collect the analytic or data from the first communication network in block 630 includes the operations of sub-block 631, where the NWDAF can obtain, from the UDM, an indication that the UE is roaming outside of the HPLMN. In some further variants, the indication that the UE is roaming outside of the HPLMN is an identifier associated with an AMF serving the UE, which includes an identifier of the VPLMN.

In addition, FIG. 7 illustrates an exemplary method (e.g., procedure) for a consumer GEF (cGEF) of a communication network (e.g., 5GC), according to various embodiments of the present disclosure. The exemplary method shown in FIG. 7 can be performed by a GEF (or network node hosting the same) such as described elsewhere herein.

The exemplary method can include the operations of block 720, where the cGEF can receive, from an NWDAF of the communication network, a request for an analytic or data that is generated by a data producer NF of a first communication network. The exemplary method can also include the operations of block 740, where the cGEF can forward (i.e. send) the request for the analytic or data to a gateway exposure function (pGEF) of the first communication network. The exemplary method can also include the operations of blocks 750-760, where the cGEF can receive the requested analytic or data from the pGEF and forward the received analytic or data to the NWDAF. Unless otherwise noted, the terms “forward” or “forwarding” are used interchangeably herein with the terms “send” and “sending”.

In some embodiments, the exemplary method can also include the operations of block 730, where the cGEF can discover the pGEF of the first communication network via an NRF of the communication network. In some embodiments, the exemplary method can also include the operations of block 710, where the cGEF can, before receiving the request (e.g., in block 720), register with the NRF identities of one or more other communication networks from which the cGEF can collect analytics or data, including the first communication network.

In some embodiments, the cGEF is provisioned with policies and/or constraints for one or more of the following collecting analytics or data from other communication networks, and providing analytics or data to other communication networks. In such embodiments, forwarding the request for the analytic or data to the pGEF is performed (e.g., in block 740) in accordance with the provisioned policies and/or constraints.

In some embodiments, the analytic or data is associated with a UE that is roaming in a VPLMN. In some of these embodiments, the communication network is the UE's VPLMN and the first communication network is the UE's HPLMN. FIG. 4 shows an example of these embodiments. In other embodiments, the communication network is the UE's HPLMN and the first communication network is the UE's VPLMN. FIG. 5 shows an example of these embodiments.

In various embodiments, the cGEF is part of one of the following in the communication network: the NWDAF, a DCCF, a network exposure function (NEF), a service communication proxy (SCP), or a security edge protection proxy (SEPP).

In embodiments in which the cGEF is part of the NWDAF, the NWDAF may be referred to as a roaming entry NWDAF (RE-NWDAF). A RE-NWDAF is a NWDAF with roaming entry capability, and may act as an entry point for data/analytics exchange between PLMNs.

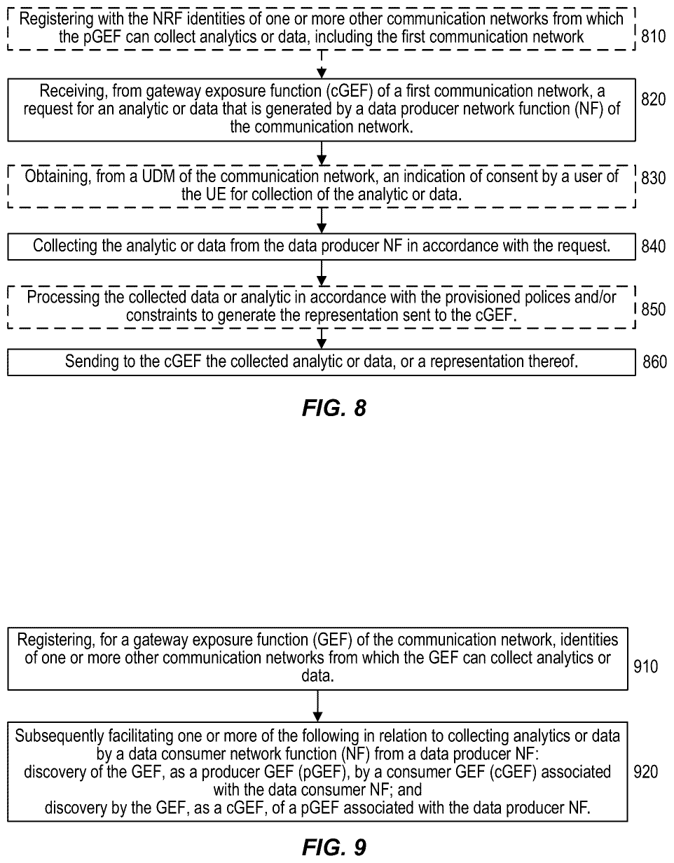

In addition, FIG. 8 illustrates an exemplary method (e.g., procedure) for a producer GEF (pGEF) of a communication network (e.g., 5GC), according to various embodiments of the present disclosure. The exemplary method shown in FIG. 8 can be performed by a GEF (or network node hosting the same) such as described elsewhere herein.

The exemplary method can include the operations of block 820, where the pGEF can receive, from a gateway exposure function (cGEF) of a first communication network, a request for an analytic or data that is generated by a data producer NF of the communication network. The exemplary method can also include the operations of block 840, where the pGEF can collect the analytic or data from the data producer NF in accordance with the request. The exemplary method can also include the operations of block 860, where the pGEF can send to the cGEF the collected analytic or data, or a representation thereof.

In some embodiments, the exemplary method can also include the operations of block 810, where the pGEF can, before receiving the request (e.g., in block 820), register with an NRF of the communication network identities of one or more other communication networks from which the pGEF can collect analytics or data.

In some embodiments, the pGEF is provisioned with policies and/or constraints for one or more of the following: collecting analytics or data from other communication networks, and providing analytics or data to other communication networks. In some of these embodiments, the exemplary method can also include the operations of block 850, where the pGEF can process the collected data or analytic in accordance with the provisioned polices and/or constraints to generate the representation sent to the cGEF (e.g., in block 860). In some variants, processing the collected data can include one or more of the following operations: removing sensitive or confidential data, modifying granularity of the analytic or data, formatting of the analytic or data, anonymization of the analytic or data.

In some embodiments, the analytic or data is associated with a UE that is roaming in a VPLMN. In some of these embodiments, the communication network is the UE's VPLMN and the first communication network is the UE's HPLMN. FIG. 5 shows an example of these embodiments. In other embodiments, the communication network is the UE's HPLMN and the first communication network is the UE's VPLMN. FIG. 4 shows an example of these embodiments. In some of these embodiments, the exemplary method can also include the operations of block 830, where the pGEF can obtain, from a UDM of the communication network, an indication of consent by a user of the UE for collection of the analytic or data. Collecting the analytic or data (e.g., in block 840) is based on the indication of consent.

In various embodiments, the pGEF is part of one of the following in the communication network: an NWDAF, a DCCF, an NEF, an SCP, or a SEPP.

In addition, FIG. 9 illustrates an exemplary method (e.g., procedure) for an NRF of a communication network (e.g., 5GC), according to various embodiments of the present disclosure. The exemplary method shown in FIG. 9 can be performed by an NRF (or network node hosting the same) such as described elsewhere herein.

The exemplary method can include the operations of block 910, where the NRF can register, for a GEF of the communication network, identities of one or more other communication networks from which the GEF can collect analytics or data. The exemplary method can also include the operations of block 920, where the NRF can subsequently facilitate one or more of the following in relation to collecting analytics or data by a data consumer network function (NF) from a data producer NF:
discovery of the GEF, as a producer GEF (pGEF), by a consumer GEF (cGEF) associated with the data consumer NF; and
discovery by the GEF, as a cGEF, of a pGEF associated with the data producer NF.

In some embodiments, the analytics or data are associated with a UE that is roaming in a VPLMN. In some of these embodiments, the communication network is the UE's VPLMN and the data consumer NF is in the UE's HPLMN. FIG. 5 shows an example of these embodiments. In other embodiments, the communication network is the UE's HPLMN and the data consumer NF is in the UE's VPLMN. FIG. 4 shows an example of these embodiments.

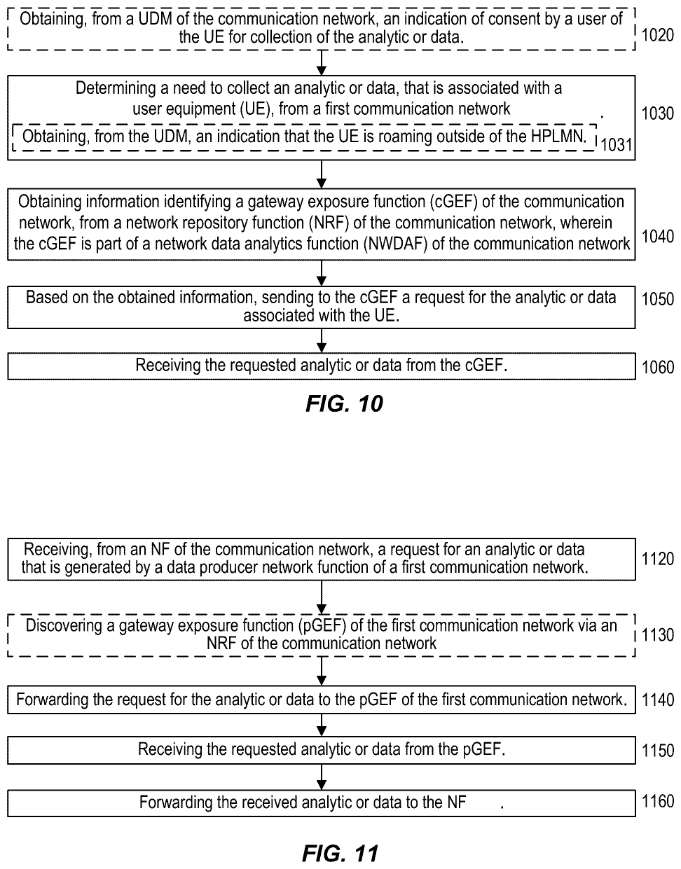

In addition, FIG. 10 illustrates an exemplary method (e.g., procedure) for an NF of a communication network (e.g., 5GC), according to various embodiments of the present disclosure. The exemplary method shown in FIG. 10 can be performed by an NF (or network node hosting the same) such as described elsewhere herein. The NF of the communication network may be a data consumer NF of the communication network.

The exemplary method can include the operations of block 1040, where the NF can, in response to determining a need to obtain an analytic or data, that is associated with a user equipment (UE), from a first communication network (e.g., in block 1030), obtain information identifying a gateway exposure function (cGEF) of the communication network, from an NRF of the communication network, wherein the cGEF is part of a network data analytics function (NWDAF) of the communication network. The NWDAF may be referred to as a roaming entry NWDAF (RE-NWDAF). A RE-NWDAF is a NWDAF with roaming entry capability, and may act as an entry point for data/analytics exchange between PLMNs.

That is, in block 1040, a NF that needs analytics or data from another PLMN contacts the GEF.

The exemplary method can also include the operations of block 1050, where the NF can, based on the obtained information, send to the cGEF a request for the analytic or data associated with the UE. The exemplary method can also include the operations of block 1060, where the NF can receive the requested analytic or data from the cGEF.

In some embodiments, the communication network is the UE's visited public land mobile network (VPLMN) and the first communication network is the UE's home public land mobile network (HPLMN). FIG. 4 shows an example of these embodiments.

In some of these embodiments, determining the need to obtain the analytic or data, that is associated with a user equipment (UE), from the first communication network (e.g., in block 1030) is based on one of the following included with the request: an analytic identifier, a SUPI or an explicit indication that the requested analytic requires data from the first communication network.

In other embodiments, the communication network is the UE's HPLMN and the first communication network is the UE's VPLMN. FIG. 5 shows an example of these embodiments. In some of these embodiments, the exemplary method can also include the operations of block 1020, where the NF can obtain, from a UDM of the communication network, an indication of consent by a user of the UE for collection of the analytic or data.

In some of these embodiments, determining the need to collect the analytic or data from the first communication network in block 1030 includes the operations of sub-block 1031, where the NF can obtain, from the UDM, an indication that the UE is roaming outside of the HPLMN. In some further variants, the indication that the UE is roaming outside of the HPLMN is an identifier associated with an AMF serving the UE, which includes an identifier of the VPLMN.

In addition, FIG. 11 illustrates an exemplary method (e.g., procedure) for a consumer GEF (cGEF) of a communication network (e.g., 5GC), wherein the cGEF is part of a network data analytics function (NWDAF) of the communication network, according to various embodiments of the present disclosure. The NWDAF may be referred to as a roaming entry NWDAF (RE-NWDAF). A RE-NWDAF is a NWDAF with roaming entry capability, and may act as an entry point for data/analytics exchange between PLMNs. The exemplary method shown in FIG. 11 can be performed by a GEF (or network node hosting the same) such as described elsewhere herein.

The exemplary method can include the operations of block 1120, where the cGEF can receive, from an NF of the communication network, a request for an analytic or data that is generated by a data producer network function of a first communication network. That is, in block 1120, the GEF is contacted by a NF that needs analytics or data from another PLMN. The NF of the communication network may be a data consumer NF of the communication network.

The exemplary method can also include the operations of block 1140, where the cGEF can forward the request for the analytic or data to a gateway exposure function (pGEF) of the first communication network. The exemplary method can also include the operations of blocks 1150-1160, where the cGEF can receive the requested analytic or data from the pGEF and forward the received analytic or data to the NF.

In some embodiments, the exemplary method can also include the operations of block 1130, where the cGEF can discover the pGEF of the first communication network via an NRF of the communication network.

In some embodiments, the cGEF is provisioned with policies and/or constraints for one or more of the following collecting analytics or data from other communication networks, and providing analytics or data to other communication networks. In such embodiments, forwarding the request for the analytic or data to the pGEF is performed (e.g., in block 1140) in accordance with the provisioned policies and/or constraints.

In some embodiments, the analytic or data is associated with a UE that is roaming in a VPLMN. In some of these embodiments, the communication network is the UE's VPLMN and the first communication network is the UE's HPLMN. FIG. 4 shows an example of these embodiments. In other embodiments, the communication network is the UE's HPLMN and the first communication network is the UE's VPLMN. FIG. 5 shows an example of these embodiments. Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

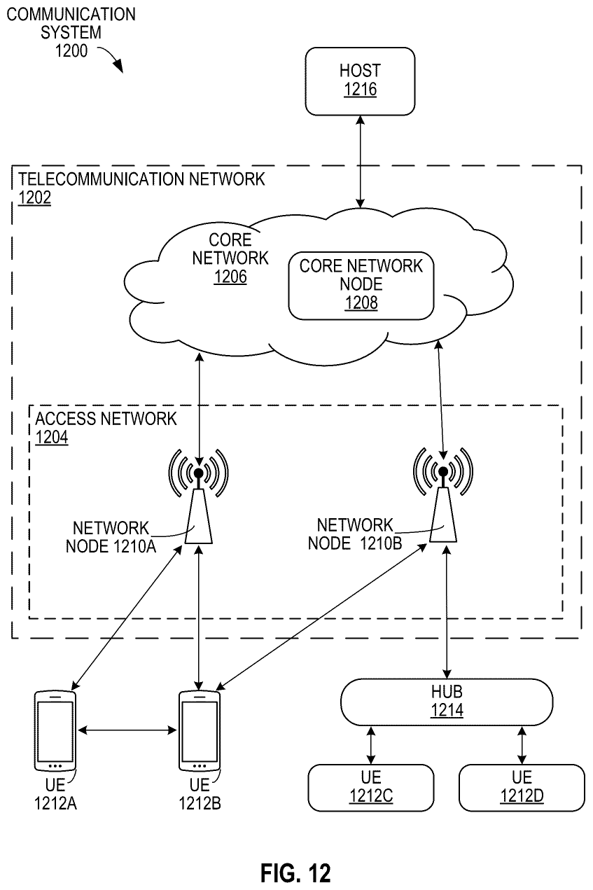

FIG. 12 shows an example of a communication system 1200 in accordance with some embodiments. In this example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3^{rd} Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), gateway exposure function (GEF), network repository function (NRF), network data analytics function (NWDAF), network function (NF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy loT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

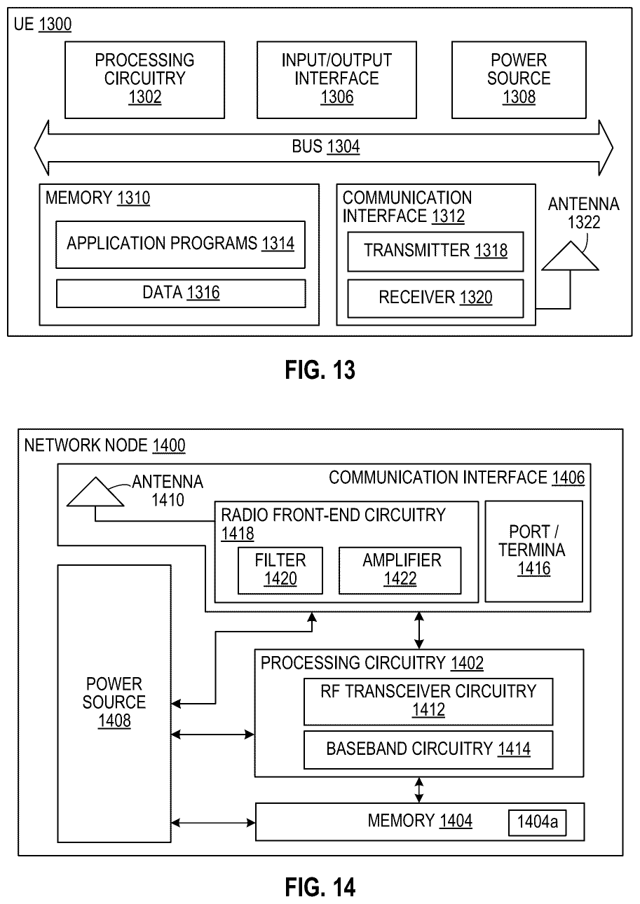

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an loT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE (or wireless device) and/or with other network nodes or equipment, in a telecommunication network (or a wireless network) to enable and/or provide wireless access to the UE and/or to perform other functions (e.g., administration) in the telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a UE with access to the telecommunication network or to provide some service to UE that has accessed the telecommunication network.

The network node 1400 includes a processing circuitry 1402, a memory 1404, a communication interface 1406, and a power source 1408.

The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400. The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions (collectively denoted computer program product 1404a) capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

In various embodiments, network node 1400 (and its constituent components) can be configured to perform operations comprising various methods described herein, such as methods performed by a gateway exposure function (GEF), network repository function (NRF), network data analytics function (NWDAF) and a network function (NF).

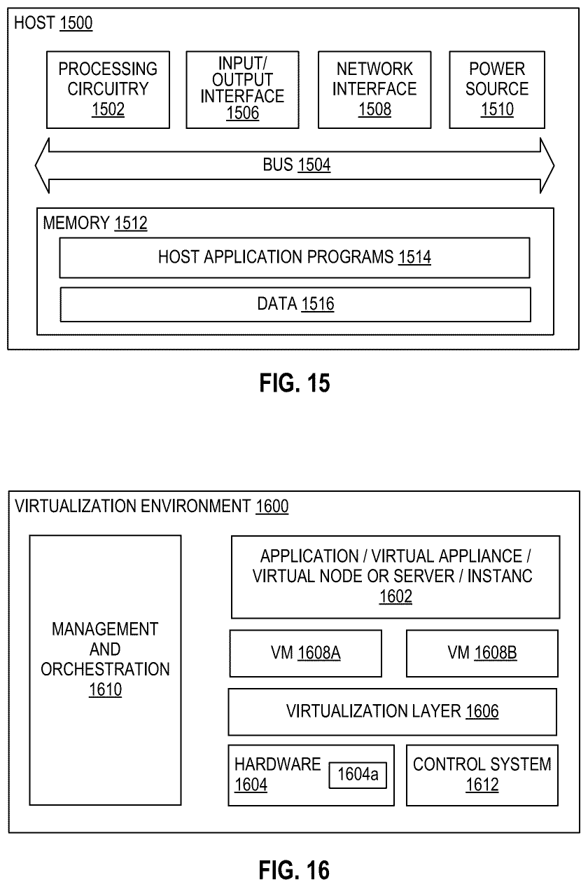

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment 1600 to implement some of the features, functions, and/or benefits of some of the embodiments disclosed herein. For example, in various embodiments, various gateway exposure functions (GEF), network repository functions (NRF), network data analytics functions (NWDAF), and network functions (NF) described herein can be instantiated as virtual NFs in environment 1600, such that each instantiation performs operations corresponding to methods (or procedures) described elsewhere herein.

Hardware 1604 includes processing circuitry, memory that stores software and/or instructions executable by hardware processing circuitry (collectively denoted computer program product 1604a), and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g., such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

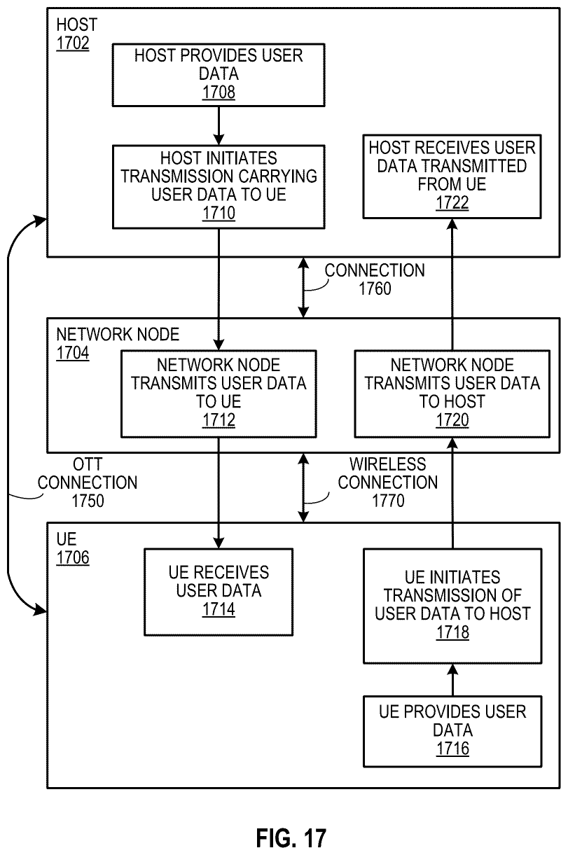

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1300, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, embodiments can improve inter-network data collection in UE roaming scenarios based on a gateway exposure function (GEF) that handles requests from data consumer NFs towards data producer NFs in other networks. Accordingly, data producer NFs do not need to implement regulatory constraints and agreements for roaming cases, and impact to existing 3GPP specifications (and existing implementations) is relatively small. In this manner, embodiments can facilitate inter-network data collection and analysis, which can improve network performance. Such improved network performance can increase the value of OTT services delivered via the network to both service providers and end users.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein also include, but are not limited to, the following enumerated embodiments:
1. A method for a network data analytics function (NWDAF) of a communication network, the method comprising:
   receiving, from a data consumer network function (NF) of the communication network, a request for an analytic or data associated with a user equipment (UE);
   in response to determining a need to collect the analytic or data from a first communication network, obtaining information identifying a gateway exposure function (cGEF) of the communication network, from a network repository function (NRF) of the communication network;
   based on the obtained information, sending to the cGEF a request for the analytic or data associated with the UE; and
   receiving the requested analytic or data from the cGEF.
2. The method of embodiment 1, wherein:
   the communication network is the UE's visited public land mobile network (VPLMN); and
   the first communication network is the UE's home public land mobile network (HPLMN).
3. The method of embodiment 2, wherein the request includes an identifier of the UE and obtaining information identifying the cGEF from the NRF comprises:
   obtaining an identifier of the UE's HPLMN from the UE identifier included in the request;
   sending the identifier of the UE's HPLMN to the NRF; and
   receiving the information identifying the cGEF from the NRF.
4. The method of any of embodiments 2-3, wherein determining the need to collect the analytic or data from the first communication network is based on one of the following included with the request: an analytic identifier, or an explicit indication that the requested analytic requires data from the first communication network.
5. The method of embodiment 1, wherein:
   the communication network is the UE's home public land mobile network (HPLMN); and
   the first communication network is the UE's visited public land mobile network (VPLMN).
6. The method of embodiment 5, further comprising obtaining, from a unified data management function (UDM) of the communication network, an indication of consent by a user of the UE for collection of the analytic or data.
7. The method of embodiment 6, wherein determining the need to collect the analytic or data from a first communication network comprises obtaining, from the UDM, an indication that the UE is roaming outside of the HPLMN.
8. The method of embodiment 7, wherein the indication that the UE is roaming outside of the HPLMN is an identifier associated with an access and mobility management function (AMF) serving the UE, which includes an identifier of the VPLMN.
9. A method for a gateway exposure function (cGEF) of a communication network, the method comprising:
   receiving, from a network data analytics function (NWDAF) of the communication network, a request for an analytic or data that is generated by a data producer network function (NF) of a first communication network;
   forwarding the request for the analytic or data to a gateway exposure function (pGEF) of the first communication network;
   receiving the requested analytic or data from the pGEF; and
   forwarding the received analytic or data to the NWDAF.
10. The method of embodiment 9, further comprising discovering the pGEF of the first communication network via a network repository function (NRF) of the communication network.
11. The method of embodiment 10, further comprising, before receiving the request, registering with the NRF identities of one or more other communication networks from which the cGEF can collect analytics or data, including the first communication network.
12. The method of any of embodiments 9-11, wherein:
   the cGEF is provisioned with policies and/or constraints for one or more of the following collecting analytics or data from other communication networks, and providing analytics or data to other communication networks; and
   forwarding the request for the analytic or data to the pGEF is performed in accordance with the provisioned policies and/or constraints.
13. The method of any of embodiments 9-12, wherein the analytic or data is associated with a user equipment (UE) that is roaming in a visited public land mobile network (VPLMN).
14. The method of embodiment 13, wherein:
   the communication network is the UE's VPLMN; and
   the first communication network is the UE's home public land mobile network (HPLMN).
15. The method of embodiment 13, wherein:
   the communication network is the UE's home public land mobile network (HPLMN); and
   the first communication network is the UE's VPLMN.
16. The method of any of embodiments 9-15, wherein the cGEF is part of one of the following in the communication network: the NWDAF, data collection coordination function (DCCF), network exposure function (NEF), service communication proxy (SCP), or security edge protection proxy (SEPP).
17. A method for a gateway exposure function (pGEF) in a communication network, the method comprising:
   receiving, from a gateway exposure function (cGEF) of a first communication network, a request for an analytic or data that is generated by a data producer network function (NF) of the communication network;
   collecting the analytic or data from the data producer NF in accordance with the request; and
   sending to the cGEF the collected analytic or data, or a representation thereof.
18. The method of embodiment 17, further comprising, before receiving the request, registering, with a network repository function (NRF) of the communication network, identities of one or more other communication networks from which the pGEF can collect analytics or data.
19. The method of any of embodiments 17-18, wherein the pGEF is provisioned with policies and/or constraints for one or more of the following: collecting analytics or data from other communication networks, and providing analytics or data to other communication networks.
20. The method of embodiment 19, further comprising processing the collected data or analytic in accordance with the provisioned polices and/or constraints to generate the representation sent to the cGEF.
21. The method of embodiment 20, wherein processing the collected data includes one or more of the following operations: removing sensitive or confidential data, modifying granularity of the analytic or data, formatting of the analytic or data, anonymization of the analytic or data.
22. The method of any of embodiments 17-21, wherein the analytic or data is associated with a user equipment (UE) that is roaming in a visited public land mobile network (VPLMN).
23. The method of embodiment 22, wherein:
   the communication network is the UE's VPLMN; and
   the first communication network is the UE's home public land mobile network (HPLMN).
24. The method of embodiment 22, wherein:
   the communication network is the UE's home public land mobile network (HPLMN); and
   the first communication network is the UE's VPLMN.
25. The method of embodiment 24, further comprising obtaining, from a unified data management function (UDM) of the communication network, an indication of consent by a user of the UE for collection of the analytic or data, wherein collecting the analytic or data is based on the indication of consent.
26. The method of any of embodiments 17-25, wherein the pGEF is part of one of the following in the communication network: network data analytics function (NWDAF), data collection coordination function (DCCF), network exposure function (NEF), and service communication proxy (SCP), and security edge protection proxy (SEPP).
27. A method for a network repository function (NRF) of a communication network, the method comprising:
   registering, for a gateway exposure function (GEF) of the communication network, identities of one or more other communication networks from which the GEF can collect analytics or data; and
   subsequently facilitating one or more of the following in relation to collecting analytics or data by a data consumer network function (NF) from a data producer NF:
      discovery of the GEF, as a producer GEF (pGEF), by a consumer GEF (cGEF) associated with the data consumer NF; and
      discovery by the GEF, as a cGEF, of a pGEF associated with the data producer NF.
28. The method of embodiment 27, wherein the analytics or data are associated with a user equipment (UE) that is roaming in a visited public land mobile network (VPLMN).
29. The method of embodiment 28, wherein:
   the communication network is the UE's VPLMN; and
   the data consumer NF is in the UE's home public land mobile network (HPLMN).
30. The method of embodiment 28, wherein:
   the communication network is the UE's home public land mobile network (HPLMN); and
   the data consumer NF is in the UE's VPLMN.
31. A network data analytics function (NWDAF) of a communication network, wherein:
   the NWDAF is implemented by communication interface circuitry and processing circuitry that are operably coupled and configured to communicate with a network repository function (NRF) and a gateway exposure function (cGEF) of the communication network; and
   the processing circuitry and the communication interface circuitry are further configured to perform operations corresponding to any of the methods of embodiments 1-8.
32. A network data analytics function (NWDAF) of a communication network, the NWDAF being configured to perform operations corresponding to any of the methods of embodiments 1-8.
33. A non-transitory, computer-readable medium storing computer-executable instructions that, when executed by processing circuitry associated with a network data analytics function (NWDAF) of a communication network, configure the NWDAF to perform operations corresponding to any of the methods of embodiments 1-8.
34. A computer program product comprising computer-executable instructions that, when executed by processing circuitry associated with a network data analytics function (NWDAF) of a communication network, configure the NWDAF to perform operations corresponding to any of the methods of embodiments 1-8.
35. A gateway exposure function (cGEF) of a communication network, wherein:
   the cGEF is implemented by communication interface circuitry and processing circuitry that are operably coupled and configured to communicate with a network repository function (NRF) and a network data analytics function (NWDAF) of the communication network; and
   the processing circuitry and the communication interface circuitry are further configured to perform operations corresponding to any of the methods of embodiments 9-16.
36. A gateway exposure function (cGEF) of a communication network, the cGEF being configured to perform operations corresponding to any of the methods of embodiments 9-16.
37. A non-transitory, computer-readable medium storing computer-executable instructions that, when executed by processing circuitry associated with gateway exposure function (cGEF) of a communication network, configure the cGEF to perform operations corresponding to any of the methods of embodiments 9-16.
38. A computer program product comprising computer-executable instructions that, when executed by processing circuitry associated with gateway exposure function (cGEF) of a communication network, configure the cGEF to perform operations corresponding to any of the methods of embodiments 9-16.
39. A gateway exposure function (pGEF) of a communication network, wherein:
   the pGEF is implemented by communication interface circuitry and processing circuitry that are operably coupled and configured to communicate with a network repository function (NRF) and a data producer network function (NF) of the communication network; and
   the processing circuitry and the communication interface circuitry are further configured to perform operations corresponding to any of the methods of embodiments 17-26.
40. A gateway exposure function (pGEF) of a communication network, the pGEF being configured to perform operations corresponding to any of the methods of embodiments 17-26.
41. A non-transitory, computer-readable medium storing computer-executable instructions that, when executed by processing circuitry associated with gateway exposure function (pGEF) of a communication network, configure the pGEF to perform operations corresponding to any of the methods of embodiments 17-26.
42. A computer program product comprising computer-executable instructions that, when executed by processing circuitry associated with gateway exposure function (pGEF) of a communication network, configure the pGEF to perform operations corresponding to any of the methods of embodiments 17-26.
43. A network repository function (NRF) of a communication network, the NRF comprising:
   the NRF is implemented by communication interface circuitry and processing circuitry that are operably coupled and configured to communicate with a gateway exposure function (GEF) of the communication network and with an NRF of another communication network; and
   the processing circuitry and the communication interface circuitry are further configured to perform operations corresponding to any of the methods of embodiments 27-30.
44. A network repository function (NRF) of a communication network, the NRF being configured to perform operations corresponding to any of the methods of embodiments 27-30.
45. A non-transitory, computer-readable medium storing computer-executable instructions that, when executed by processing circuitry associated with a network repository function (NRF) of a communication network, configure the NRF to perform operations corresponding to any of the methods of embodiments 27-30.
46. A computer program product comprising computer-executable instructions that, when executed by processing circuitry associated with a network repository function (NRF) of a communication network, configure the NRF to perform operations corresponding to any of the methods of embodiments 27-30.

1. A method for a network data analytics function, NWDAF, of a communication network, the method comprising:
receiving, from a data consumer network function, NF, of the communication network, a request for an analytic or data associated with a user equipment, UE;
in response to determining a need to collect the analytic or data from a first communication network, obtaining information identifying a gateway exposure function, cGEF, of the communication network, from a network repository function, NRF, of the communication network;
based on the obtained information, sending to the cGEF a request for the analytic or data associated with the UE; and
receiving the requested analytic or data from the cGEF.

2. The method of claim 1, wherein:
the communication network is the UE's visited public land mobile network, VPLMN; and
the first communication network is the UE's home public land mobile network, HPLMN.

3. The method of claim 2, wherein determining the need to collect the analytic or data from the first communication network is based on one of the following included with the request: an analytic identifier, a Subscription Permanent Identifier, SUPI, of the UE, or an explicit indication that the requested analytic requires data from the first communication network.

4. The method of claim 1, wherein:
the communication network is the UE's home public land mobile network, HPLMN; and
the first communication network is the UE's visited public land mobile network, VPLMN.

5. The method of claim 4, further comprising obtaining, from a unified data management function, UDM, of the communication network, an indication of consent by a user of the UE for collection of the analytic or data.

6. The method of claim 5, wherein determining the need to collect the analytic or data from a first communication network comprises obtaining, from the UDM, an indication that the UE is roaming outside of the HPLMN.

7. The method of claim 6, wherein the indication that the UE is roaming outside of the HPLMN is an identifier associated with an access and mobility management function, AMF, serving the UE, which includes an identifier of the VPLMN.

8. A non-transitory, computer-readable medium storing computer-executable instructions that, when executed by processing circuitry associated with a network data analytics function, NWDAF, of a communication network, configure the NWDAF to perform operations corresponding to the method of claim 1.

9. (canceled)

10. A method for a gateway exposure function, cGEF, of a communication network, the method comprising:
receiving, from a network data analytics function, NWDAF, of the communication network, a request for an analytic or data that is generated by a data producer network function, NF, of a first communication network;
sending the request for the analytic or data to a gateway exposure function, pGEF, of the first communication network;
receiving the requested analytic or data from the pGEF; and
sending the received analytic or data to the NWDAF.

11. The method of claim 10, further comprising discovering the pGEF of the first communication network via a network repository function, NRF, of the communication network.

12. The method of claim 10, wherein:
the cGEF is provisioned with policies and/or constraints for one or more of the following collecting analytics or data from other communication networks, and providing analytics or data to other communication networks; and
sending the request for the analytic or data to the pGEF is performed in accordance with the provisioned policies and/or constraints.

13. The method of claim 10, wherein the analytic or data is associated with a user equipment, UE, that is roaming in a visited public land mobile network, VPLMN.

14. The method of claim 13, wherein:
the communication network is the UE's VPLMN; and
the first communication network is the UE's home public land mobile network, HPLMN.

15. The method of claim 13, wherein:
the communication network is the UE's home public land mobile network, HPLMN; and
the first communication network is the UE's VPLMN.

16. The method of claim 10, wherein the cGEF is part of one of the following in the communication network: the NWDAF, data collection coordination function. DCCF, network exposure function, NEF, service communication proxy. SCP, or security edge protection proxy, SEPP.

17. A non-transitory, computer-readable medium storing computer-executable instructions that, when executed by processing circuitry associated with a gateway exposure function, cGEF, of a communication network, configure the cGEF to perform operations corresponding to the method of claim 10.

18-53. (canceled)

54. A network data analytics function, NWDAF, of a communication network, wherein:
the NWDAF is implemented by communication interface circuitry and processing circuitry that are operably coupled and configured to communicate with a network repository function, NRF, and a gateway exposure function, cGEF, of the communication network; and
the processing circuitry and the communication interface circuitry are further configured to:
receive, from a data consumer network function, NF, of the communication network, a request for an analytic or data associated with a user equipment, UE;
in response to determining a need to collect the analytic or data from a first communication network, obtain information identifying a gateway exposure function, cGEF, of the communication network, from a network repository function, NRF, of the communication network;
based on the obtained information, send to the cGEF a request for the analytic or data associated with the UE; and
receive the requested analytic or data from the cGEF

55. The NWDAF of claim 54, wherein:
the communication network is the UE's visited public land mobile network, VPLMN; and
the first communication network is the UE's home public land mobile network, HPLMN.

56. The NWDAF of claim 55, wherein the processing circuitry and the communication interface circuitry are configured to determine the need to collect the analytic or data from the first communication network based on one of the following included with the request: an analytic identifier, a Subscription Permanent Identifier, SUPI, of the UE, or an explicit indication that the requested analytic requires data from the first communication network.

57. The NWDAF of claim 54, wherein:
the communication network is the UE's home public land mobile network, HPLMN; and
the first communication network is the UE's visited public land mobile network, VPLMN.

58-135. (canceled)
